(19) United States
(12) Patent Application Publication
(10) Pub. No.: US 2007/0188498 A1
(43) Pub. Date: Aug. 16, 2007

(54) CHARACTER GENERATION PROCESSING METHOD

(75) Inventors: Yasutaka OKADA, Kawasaki (JP); Satoshi Iwata, Kawasaki (JP); Masashi Takechi, Hyogo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/674,543

(22) Filed: Feb. 13, 2007

(30) Foreign Application Priority Data
Feb. 14, 2006 (JP) 2006-037147

(51) Int. Cl. G06T 11/00

(52) U.S. Cl. 345/469

(57) ABSTRACT

In order to generate a character main body including a character outline from data in which character shape information is stored as a character outline and generate a character with a design, this method comprises steps of generating the outline of the character main body, setting decoration process contents to be applied to the character main body, operating in such a way that the lower-order bits of the character gradation of the generated outline can be outline end information, setting a decoration position in a character outer fringe on the basis of the outline end information for determining on which side of the main body is located the pixel, on the left or right side, generating character decoration by controlling the gradation value of a pixel in which the flag is set and painting out the character main body excluding the generated character decoration.

### BACKGROUND OF THE INVENTION

1. Field of the Invention

The present invention relates to a character generation processing method for simultaneously generating a character main body and a character outline from data in which character shape information is stored as character outline and generating characters with design.

2. Description of the Related Art

Conventionally dot font is used for the storage form of character design information, installed in built-in equipment, such as a cellular phone, car navigator or the like. This is because the processing capability of the conventional built-in equipment is low and a method capable of storing necessary character images inside memory without performing any process and displaying characters by simply developing the characters on a screen is efficient.

In the dot-font character expression, since characters are expressed as a group of points by painting out dots (binary expression), the processing capability needed to generate characters can be lowered. However, it is difficult to express character images with a design such as enlargement/compression, transformation or decoration. Since a font file is prepared for each character size, there is a restriction in the expression of character images with designs, of built-in equipment which has only a limited storage capacity.

A storage method called outline font, in which the character design information is stored by outline, is also known. This storage method of a character design information stores lines which express a character outline as one piece of character information by the coordinate data of peaks and functional data expressing straight and curved lines. In this case, at the time of character expression, a character is generated by calculating the equation of a curved line, calculating the arrangement of points to be plotted and painting out its interior after plotting its outline. Therefore, even when enlargement/compression or transformation is performed, its character shape is not destroyed, thereby expressing characters with designs.

However, since this method takes more character generation time compared with the dot font format, conventionally it is difficult to apply this method to built-in equipment with low processing capability. However, the performance of built-in equipment is improved and there is an increased need for expressing characters with designs, using outline font format even in built-in equipment.

For example, when overlapping characters and graphics on a complex pattern or background and displaying them in the map of a car navigator or the like, there is no difference in contrast in the case of some combination of the color of a character or graphic to be overlapped and that of background and the visibility decreases. Therefore, there is an increased demand for using outline font format with design adaptability. By expressing characters with designs (decorating characters), the mixture with the background color can be prevented, thereby improving the visibility when overlapping characters.

As methods for expressing characters with designs by outline font, particularly a prior art for generating characters with fringe decoration, the following two methods are known.

### [The First Prior Art]

FIG. 1 shows the first prior art in order to explain a character generation process (see Patent reference 1). In FIG. 1, character decoration 204 is realized by generating an essential character image 202 and a character image 201 with a size different from that of the essential character image 202 and combining them. In FIG. 1, a fringe-decorated character is generated by overlapping the essential character image 202 on the fairly bold character 201.

FIG. 2 is a flowchart explaining the first prior art shown in FIG. 1. In FIG. 2, firstly the outline of a character with a specified character size is plotted (S202). Then, by painting out the interior of the outline (S203), the first character image 201′ is generated. Then, the outline of a character with a different size is plotted (S205). Then, by painting out the interior (S206), the second character image 202′ with a different size is generated. Lastly a decoration character 204 is generated by overlapping the first character image 201′ with the specified size and the second character image 202′ with a different size.

### [The Second Prior Art]

FIG. 3 shows the second prior art in order to explain a character generation process (see Patent reference 2). In FIG. 3, character decoration 216 whose outline is hemmed at a certain width is realized by having core-line information 212 for a character decoration process in addition to the essential outline information as another piece of data, generating an outliner 213 necessary for the character decoration, using the core-line information 212 and combining them. Specifically, character decoration 216 whose outline is hemmed at a certain width is realized by generating an outline 213, using core-line information 212 different from the outline information 211, generating an inline pattern 214 and combining them.

FIG. 4 is a flowchart explaining the second prior art shown in FIG. 3. In FIG. 4, firstly the outline of a character with a specified character size is plotted (S212). Then, by painting out the interior of the outline (S213), a character image 211′ is generated.

Then, by reading core-line information 212 (S215) and newly generating an outline 213 outside the core line by the extent specified by its line width, an inline pattern 214 is generated (S216). Lastly, by overlapping the generated character image 211′ and the inline pattern 214 (S217), a decoration character 216 is generated.

In the above-described decoration character generation methods of the first and second prior arts, character decoration id realized by separately generating the bit map pattern of the character main body and that of character decoration and combining or overlapping them.,

Therefore, there are the following problems.
(1) Since a bit-map development area for two characters is necessary on memory in order to generate a character, a used memory size is large.
(2) Since a character is plotted separately from a character to be decorated and they are combined, the processing speed is slow.
(3) Since a uniform process is performed not depending on the character gradation value of an outline, sometimes the outline of the character main body and the fringe of the decoration character overlap. Therefore, the appearance of a decorated character is bad and its image quality is also low.
   Patent reference 1: Japanese Patent Application No. H9-90933
   Patent reference 2: Japanese Patent Application No. H11-288261

### SUMMARY OF THE INVENTION

It is an object of the present invention to realize character expression with a design in a character generation processing method for generating characters in an outline font format, in which the decoration character generation process is of high speed, the used size of memory necessary for a character pattern development area and that of a font file size are small and character quality is assured.

In order to attain the above-described objective, the character generation processing method of the present invention comprises a process of generating the outline of a character main body in order to generate a character main body including a character outline from data in which character shape information is stored as a character outline and to generate a character with a design, a process of setting the decoration process contents to be applied to the character main body, a process of operating in such a way as to specify the lower-order bit of the character gradation value of the generated outline as outline end information, a process of setting a decoration position in a character outer fringe, based on the outline end information for determining whether it is at the left or right end of the main body and the character gradation value of the outline and setting a flag in the position, a process of generating the decoration of the character by controlling the gradation value of a pixel in which the flag is set and a process of painting out the character main body excluding the outline of the generated character.

Thus, the present invention can simultaneously generate the main body and outline of a character to be decorated, by raising a flag indicating a decoration process area outside with an arbitrary width according to the gradation value of the character outline when generating the character outline, thereby reducing the used size of memory necessary for a character pattern development area and that of a font file size.

When applying character expression with a design to an outline font, by appropriately selecting the fringe gradation against the character gradation, the present invention can flexibly correspond to a character design including character decoration. Therefore, characters with good appearance can be generated.

### BRIEF DESCRIPTION OF THE DRAWINGS

FIG. 1 explains the first prior art;

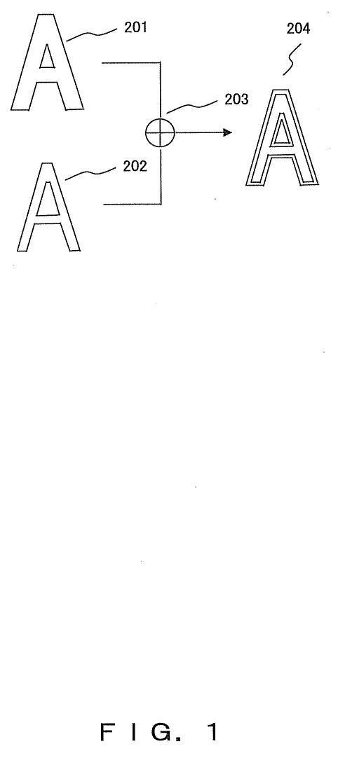

FIG. 2 is a flowchart explaining the operation of the first prior art;

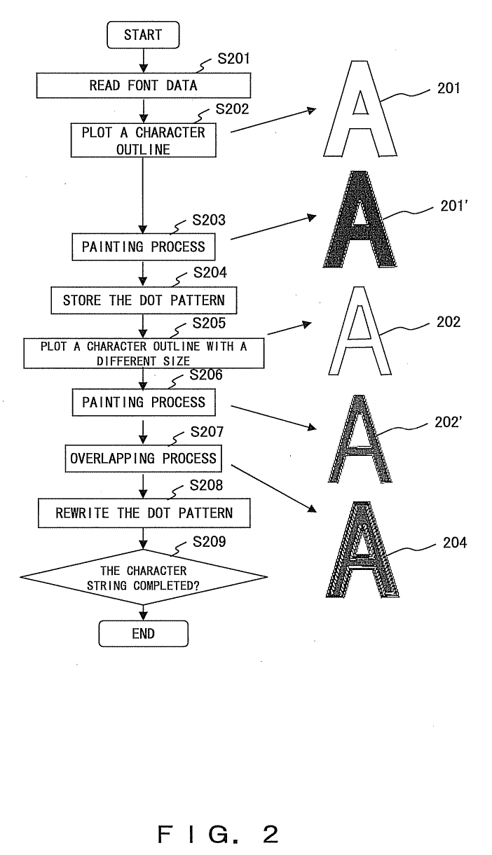

FIG. 3 explains the second prior art;

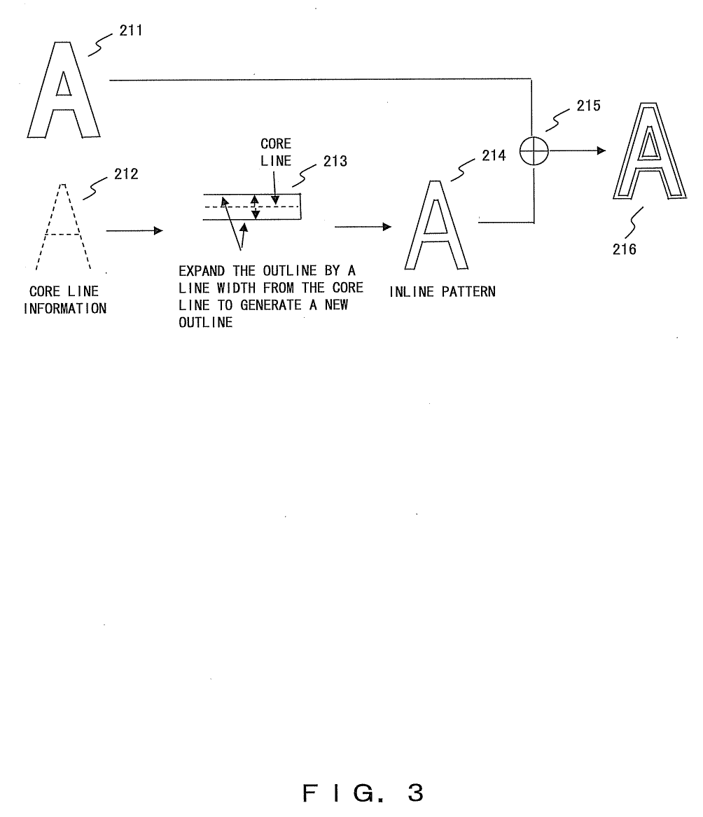

FIG. 4 is a flowchart explaining the operation of the second prior art;

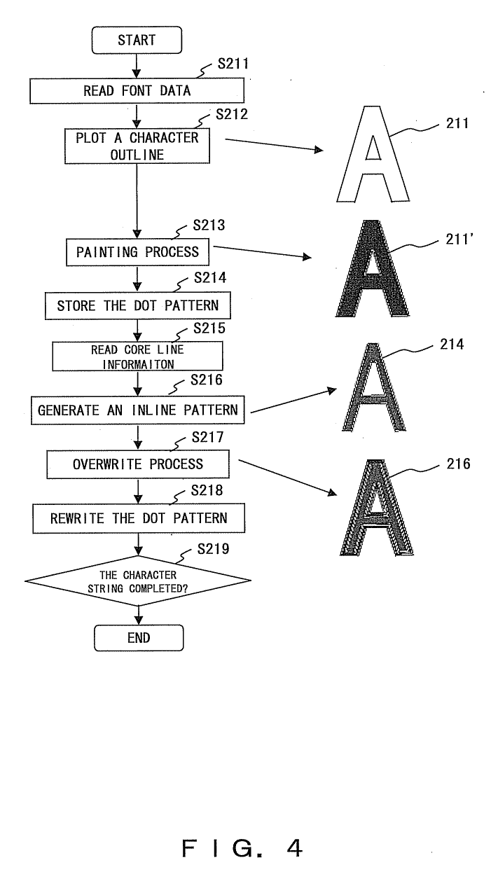

FIG. 5 is a block diagram showing the basic configuration of the character generation processing device of the preferred embodiment of the present invention;

FIG. 6 is an operational flowchart explaining the basic process of the character generation processing method of the preferred embodiment of the present invention;

FIG. 7 is a flowchart explaining the whole process in which the character generation processing method of the preferred embodiment of the present invention is simplified;

FIG. 8 shows the result of operating in such a way as to indicating the outline end information of the preferred embodiment of the present invention;

FIG. 9 shows the state of memory where outline font data is developed after the decoration flag of the preferred embodiment of the present invention is set;

FIG. 10 explains the basic setting mechanism of the decoration flag of the preferred embodiment of the present invention;

FIG. 11 explains the first position setting method of the decoration flag of the preferred embodiment of the present invention;

FIG. 12 explains the second position setting method of the decoration flag of the preferred embodiment of the present invention;

FIG. 13A is a main flowchart explaining the operation of the decoration flag position setting process and decoration flag setting process of the preferred embodiment of the present invention;

FIG. 13B is the first sub-flowchart explaining the operation of the decoration flag position setting process and the decoration flag setting process of the preferred embodiment of the present invention;

FIG. 13C is the second sub-flowchart explaining the operation of the decoration flag position setting process and the decoration flag setting process of the preferred embodiment of the present invention;

FIG. 13D is the third sub-flowchart explaining the operation of the decoration flag position setting process and the decoration flag setting process of the preferred embodiment of the present invention;

FIG. 13E is the fourth sub-flowchart explaining the operation of the decoration flag position setting process and the decoration flag setting process of the preferred embodiment of the present invention;

FIG. 14 explains a range that affects the decoration flag position setting of the preferred embodiment of the present invention;

FIG. 15 shows the first format example indicating where of the gradation value the decoration flag of the preferred embodiment of the present invention is assigned;

FIG. 16 shows the pixel value-flag correspondence table in the first format example shown in FIG. 15;

FIG. 17 shows the second format example indicating where of the gradation value the decoration flag of the preferred embodiment of the present invention is assigned;

FIG. 18 shows the pixel value-flag correspondence table in the second format example shown in FIG. 17;

FIG. 19 is a flowchart determining the gradation value of a decoration outline using decoration process flags (ID Nos.) shown in FIGS. 17 and 18;

FIG. 20 is a timing chart explaining the gradation value process of the decoration outline according to the flowchart shown in FIG. 19;

FIG. 21 is the first flowchart explaining the whole process of the character generation processing method of the preferred embodiment of the present invention;

FIG. 22 is the second flowchart explaining the whole process of the character generation processing method of the preferred embodiment of the present invention; and

FIG. 23 shows an example of a decoration character obtained by the painting process of the preferred embodiment of the present invention.

### DESCRIPTION OF THE PREFERRED EMBODIMENT

The preferred embodiment of the present invention is described below with reference to the drawings.

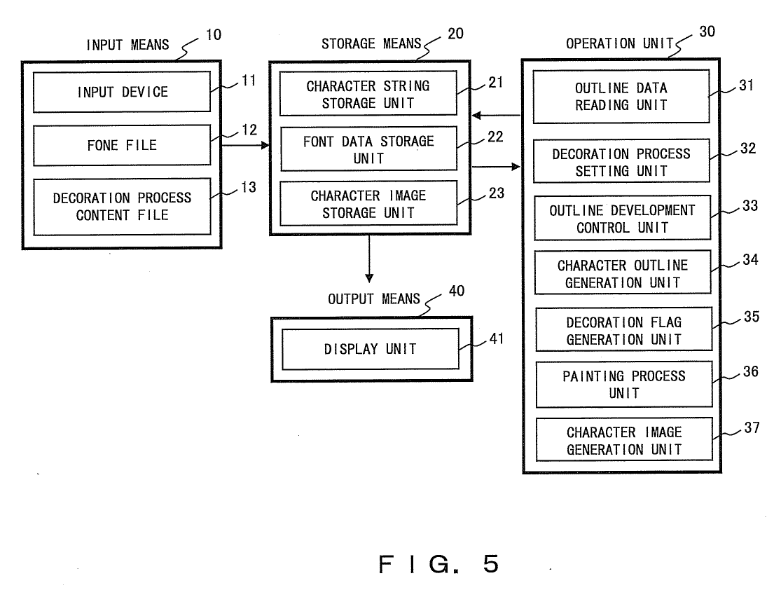

FIG. 5 is a block diagram showing the basic configuration of the character generation processing device of the preferred embodiment of the present invention. The character generation processing device of the preferred embodiment of the present invention comprises four functional block means of an input means 10, a storage means 20, an operation means 30 and an output means 40. The input means comprises an input device 11, such as a keyboard or the like, for inputting a character string, a font file 12 and a decoration process content file 13, for inputting a font data from a file. The storage means 20 comprises a character string storage unit 21 for storing an inputted character string, a font data storage unit 22 for storing an inputted font data and a character image storage unit 23 for storing a character image to be outputted to the output means 40. The operation means 30 comprises an outline data reading unit 31 for reading font data, a decoration process setting unit 32 for setting decoration process contents, an outline development control unit 33 for developing outline data, based on the decoration process contents, a character outline generation unit 34 for generating the outline of the character main body, a decoration flag generation unit 35 for generating a decoration flag, a painting process unit 36 for painting out the interior of the character main body and a character image generation unit 37 for completing the decoration character by painting out a part including the decoration flag, based on the decoration process contents. The output means 40 comprises a display device 41 for outputting the completed decoration character stored in the character image storage unit 23.

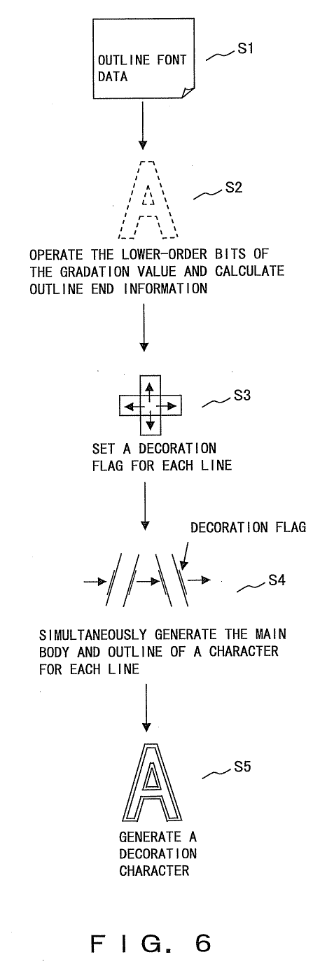

FIG. 6 is an operational flowchart explaining the basic process of the character generation processing method of the preferred embodiment of the present invention. In FIG. 6, outline font data corresponding to a character code is read per each character (S1). Then, outline end information is calculated by operating the lower-order bits of the gradation value of the outline font data (S2). Then, a decoration flag is set by referring to the gradation value of a pixel that becomes the outline end information for each line (S3). Then, the character main body and the outline fringed by the decoration flag are simultaneously generated for each line (S4). Lastly, a decoration character is generated by performing a painting process (S5).

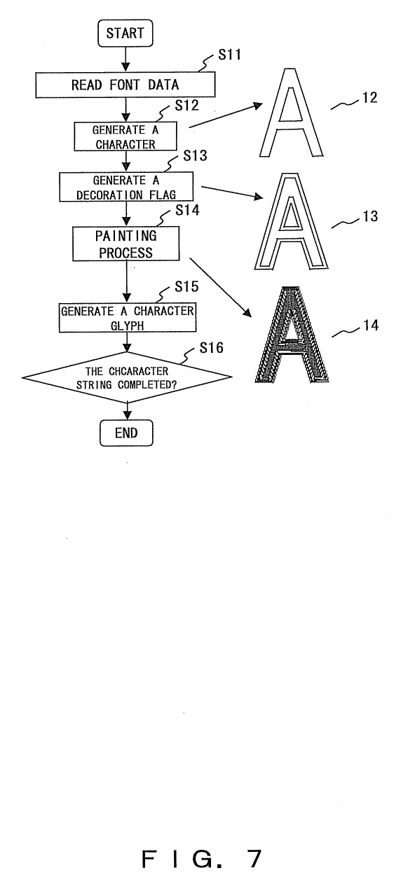

FIG. 7 is a flowchart explaining the whole process in which the character generation processing method of the preferred embodiment of the present invention is simplified. In the process of the character generation processing method of the preferred embodiment of the present invention shown in FIG. 7, a decoration character is generated by reading font data corresponding to a character code for each character. Specifically, in FIG. 7, firstly, outline font data is read (S11). Then, the outline of a character main body is generated by developing the outline font data according to a character attribute (S12). The generated outline 12 is shown on the right side by an arrow mark. Then, a decoration flag is generated according to a character decoration attribute (S13). The character 13 to which the decoration flag is attached is shown on the right side by an arrow mark. Then, a painting process is performed according to the specification of the character and decoration attributes (S14). The decoration character 14 to which the painting process is applied is shown on the right side by an arrow mark. Lastly, a character glyph is generated (S15).

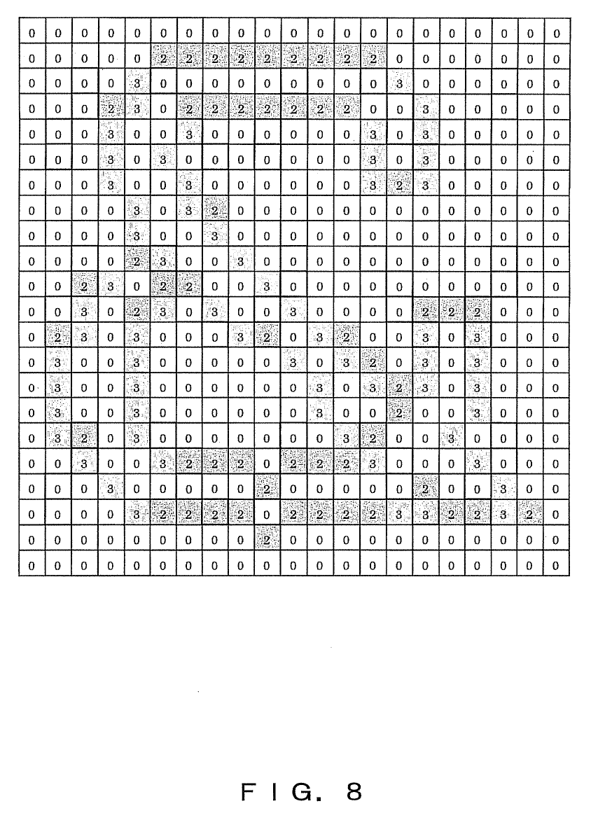

FIG. 8 shows the result of operating in such a way as to indicating the outline end information of the preferred embodiment of the present invention. In FIG. 8, outline data is developed and end information is shown by operating the two lower-order bits of the gradation value of a pixel corresponding to a character outline. The pixel (=3) in which the two lower-order bits are raised indicates a painting starting or ending pixel and the pixel (=2) in which one lower-order bit is raised indicates a single painting pixel. Thus, by referring to the two lower-order bits of the gradation value, the end information of a character outline can be known.

In order to operate in such a way as to indicate outline end information, in view of the outline font characteristic that the number of times an outline vertically crosses for each line developed on a bit map is always even, the followings are applied to all developed pixels.
(1) The two lower-order bits of a pixel which an outline crosses are raised.
(2) When an outline vertically crosses the pixel, one lower-order bit is further inverted in addition to the operation (1).

### Then, the followings are determined.

(3) The pixel in which the two lower-order bits are raised is outline end information indicating the starting or ending point of outline.
(4) The pixel in which one lower-order bit is raised is single outline end information.

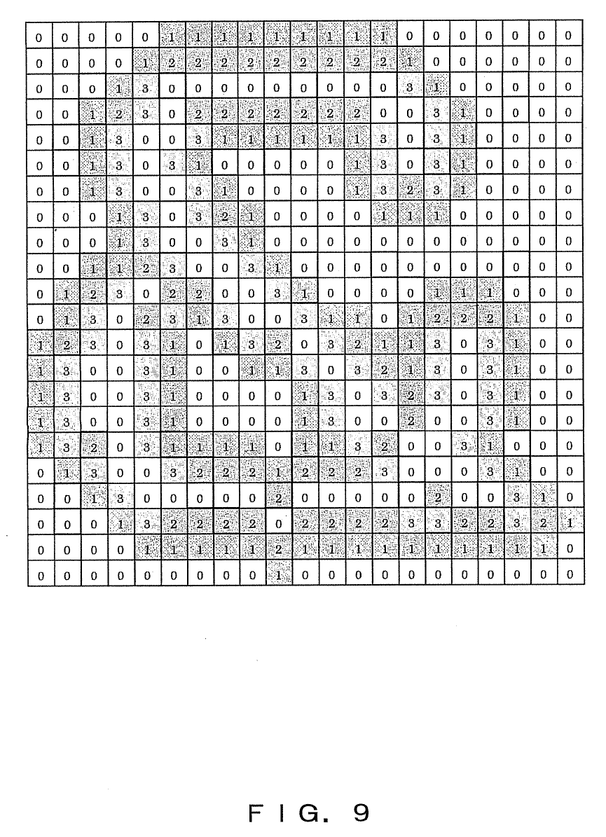

FIG. 9 shows the state of memory where outline font data is developed after the decoration flag of the preferred embodiment of the present invention is set. FIG. 9 shows that a decoration flag is set around the outline end information shown in FIG. 8.

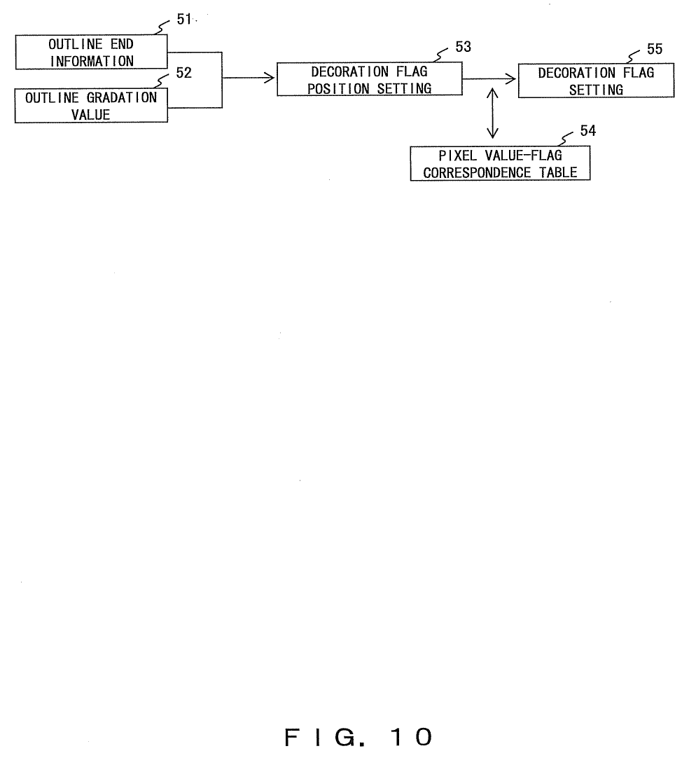

Here the setting mechanism of the decoration flag of the preferred embodiment of the present invention is described with reference to FIG. 10. FIG. 10 explains the basic setting mechanism of the decoration flag of the preferred embodiment of the present invention. Firstly, a decoration flag position 53 is set using the outline end information 51 generated by the two lower-order bit operation and gradation value 52 of the pixel corresponding to the outline of the pixel. Then, a decoration flag (flag ID) is determined referring to the pixel value of a target pixel in the pixel value-decoration flag correspondence table 54 and a decoration flag 55 is set.

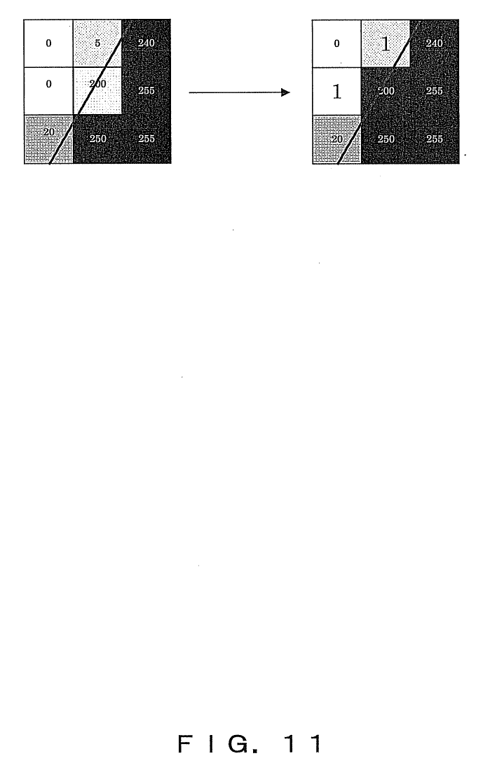

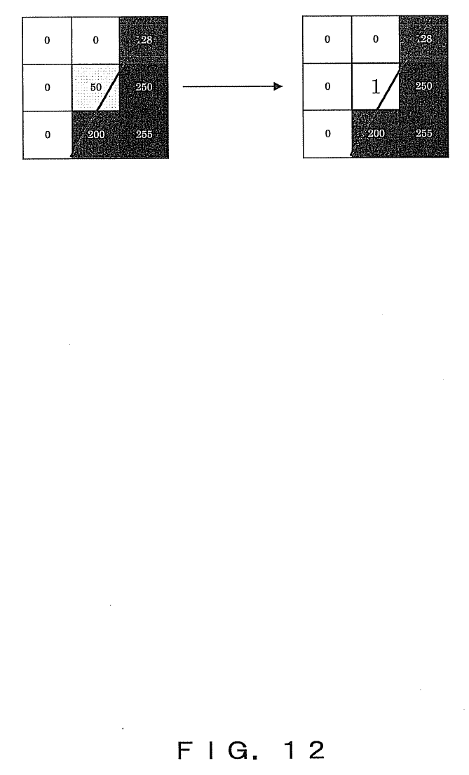

The above-described decoration flag position setting process is further described with reference to FIGS. 11 and 12. FIG. 11 explains the first position setting method of the decoration flag of the preferred embodiment of the present invention. FIG. 12 explains the second position setting method of the decoration flag of the preferred embodiment of the present invention. As shown in FIG. 11, when the pixel value (=200) of the target pixel which the outline vertically crosses is equal to or more than a threshold, the four directions (upper/lower/left/right directions) around the target pixel are assumed to be the bit operation range of the pixel value. As a result of the bit operation, in FIG. 11 a decoration flag (“1” in FIG. 11) indicating on which side of the target pixel is a decoration area is set, on the upper or left side. However, when the pixel value (=50) of the target pixel which the outline vertically crosses is less than a threshold as shown in FIG. 12, the target pixel itself is operated. As a result of the bit operation, in FIG. 12 a flag (“1” in FIG. 12) indicating a decoration area is set in the target pixel itself.

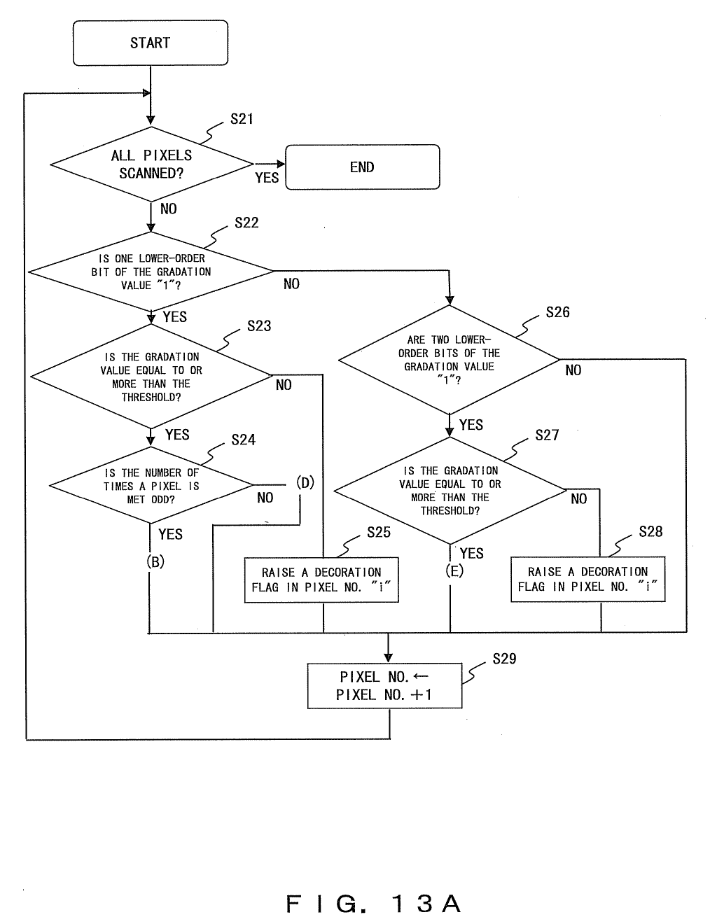

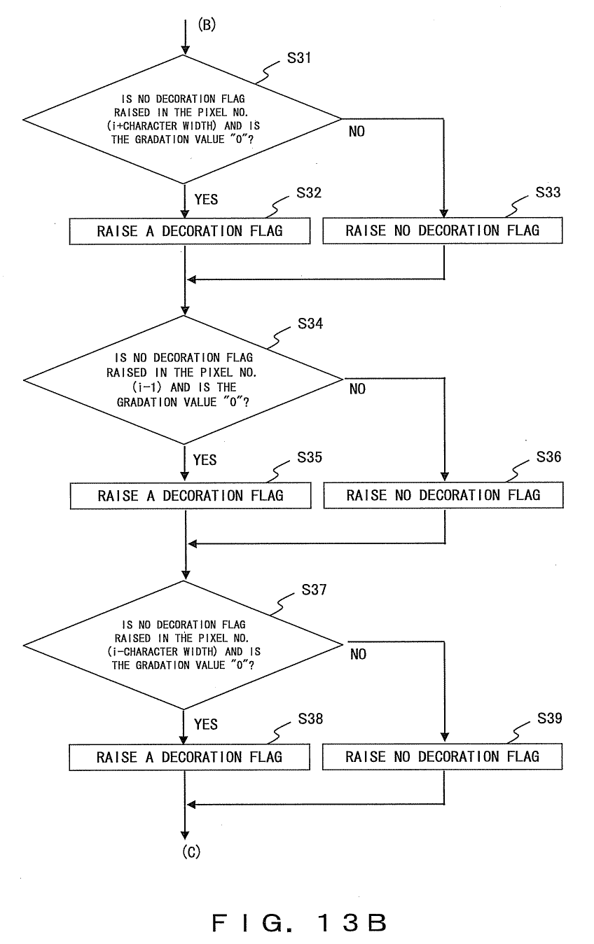

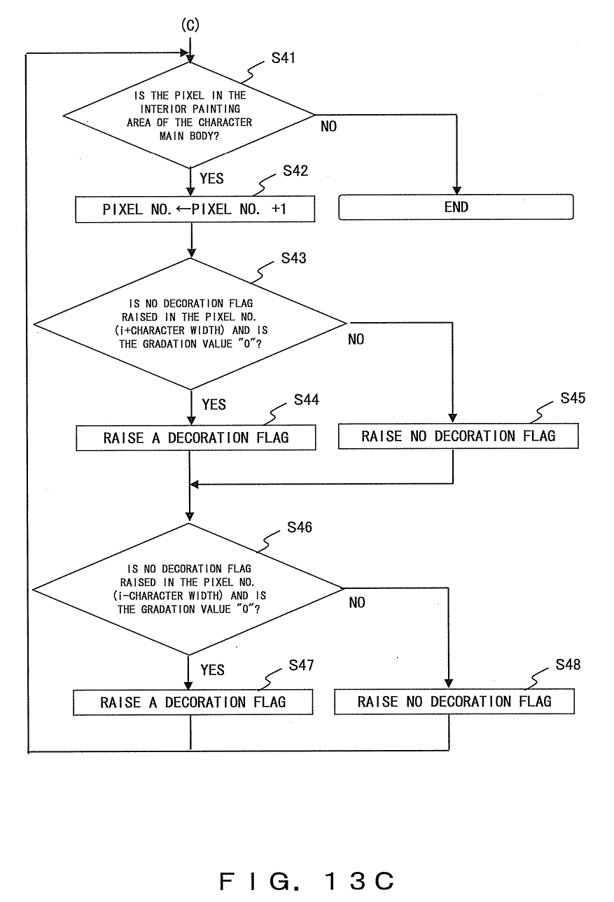

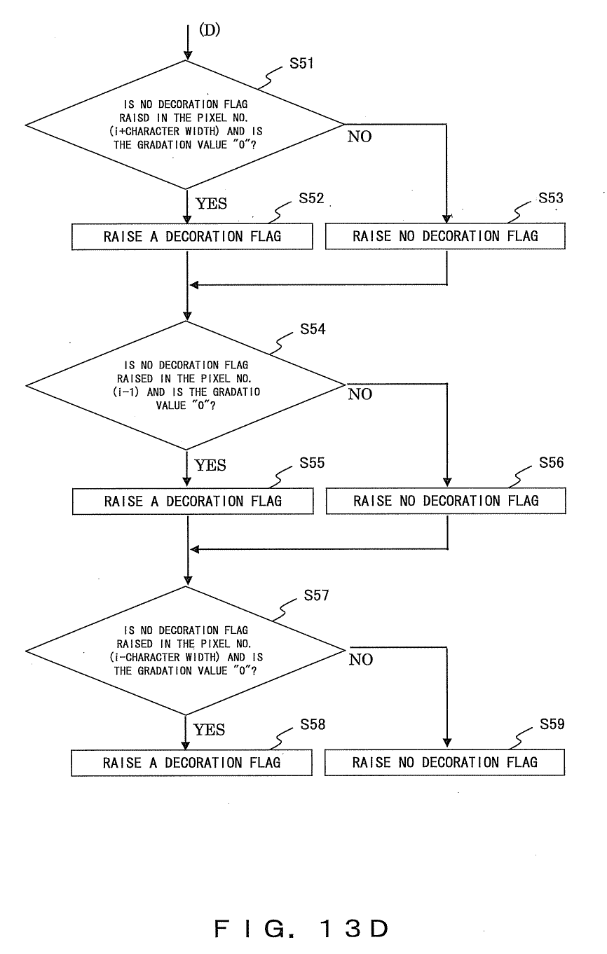

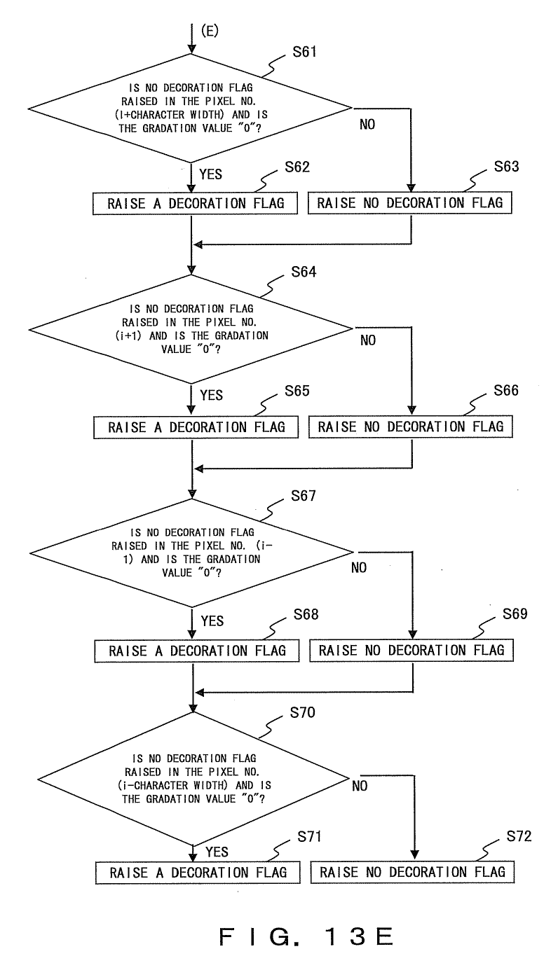

FIGS. 13A through 13E are flowcharts explaining the operation of the decoration flag position setting process and decoration flag setting process of the preferred embodiment of the present invention. FIG. 13A corresponds to a main flow and FIGS. 13B through 13E correspond to sub-flows. Firstly, the main flow shown in FIG. 13A is described. When the operation starts in FIG. 13A, it is determined whether the scan of all pixels is completed (S21). If the scan of all pixels is completed, the operation is terminated. If the scan of all pixels is not completed yet, it is determined whether the one lower-order bit of the gradation value is “1” (S22) If the one lower-order bit of the gradation value is “1”, the flow proceeds to step 23. If the one lower-order bit of the gradation value is not “1”, the flow proceeds to step 26. Instep 23 it is determined whether the gradation value is equal to or more than the threshold. If the gradation value is equal to or more than the threshold, the flow proceeds to step 24 and in step 24 it is determined whether the number of times a pixel is met is odd. If it is odd, the flow jumps to a sub-flow B (FIG. 13B). When the process of the sub-flow B is completed, the flow proceeds to step 29. In step 29 the pixel No. is incremented and the flow returns to step 21. If it is not odd, the flow jumps to a sub-flow D (FIG. 13D). When the process of the sub-flow D is completed, the flow proceeds to step 29. In step 29 the pixel number is incremented and the flow returns to step 21.

In step 26 it is determined whether the two lower-order bits of the gradation value are “1”. If the two lower-order bits of the gradation value are “1”, the flow proceeds to step 27 and in step 23 it is determined whether the gradation value is equal to or more than the threshold. If it is equal to or more than the threshold, the flow jumps to a sub-flow E (FIG. 13E). When the process of the sub-flow E is completed, the flow proceeds to step 29. In step 29 the pixel number is incremented and the flow returns to step 21.

If in step 23 the gradation value is less than the threshold, the flow proceeds to step 25. In step 25 a decoration flag is raised in a pixel No. “i” and the flow proceeds to step 29. In step 29 the pixel number is incremented and the flow returns to step 21.

In step 26 it is determined whether the two lower-order bits are “1”. If the two lower-order bits are “1”, the flow proceeds to step 27 and in step 27 it is determined whether the gradation value equal to or more than the threshold. If it is equal to or more than the threshold, the flow jumps to a sub-flow E (FIG. 13E). When the process of the sub-flow E is completed, the flow proceeds to step 29. In step 29 the pixel number is incremented and the flow returns to step 21. If it is less than the threshold, the flow proceeds to step 28. In step 28 a decoration flag is raised in the pixel No. “i” and the flow proceeds to step 29. In step 29 the pixel number is incremented and the flow returns to step 21.

If in step 26 the two lower-order bits are not “1”, the flow proceeds to step 29. In step 29 the pixel number is incremented and the flow returns to step 21.

FIG. 13B shows the sub-flow B that is jumped from step 24 of the main flow. In step 31 of FIG. 13B it is determined whether a decoration flag is raised in a pixel No. (i +character width) and whether the gradation value is “0”. If no decoration flag is raised and if the gradation value is “0”, the decoration flag is raised (S32) and the flow proceeds to step 34. If a decoration flag is raised or if no gradation value is “0”, no decoration flag is raised (S33) and the flow proceeds to step 34. In step 34 it is determined whether no decoration flag is raised in a pixel No. (i−1) and whether the gradation value is “0”. If no decoration flag is raised and if the gradation value is “0”, the decoration flag is raised (S35) and the flow proceeds to step 37. If a decoration flag is raised or if no gradation value is “0”, no decoration flag is raised (S36) and the flow proceeds to step 37. In step 37 it is determined whether no decoration flag is raised in a pixel No. (i−character width) and whether the gradation value is “0”. If no decoration flag is raised and the gradation value is “0”, the decoration flag is raised (S38) and the flow proceeds to a sub-flow C. If decoration flag is raised or if no gradation value is “0”, no decoration flag is raised (S39) and the flow proceeds to the sub-flow C.

FIG. 13C shows a sub-flow that is connected to steps 38 and 39 of the sub-flow B shown in FIG. 13B. In step 41 of Fig. FIG. 13C it is determined whether it is in the interior painting area of a character main body. If the pixel is not in the interior painting area of a character main body, the flow is terminated and returns to the main flow. If the pixel is in the interior painting area of a character main body, in step 42 a pixel No. is incremented and the flow proceeds to step 43. In step 43 it is determined whether a decoration flag is raised in a pixel No. (i+character width) and whether the gradation value is “0”. If no decoration flag is raised and if the gradation value is “0”, the decoration flag is raised (S44) and the flow proceeds to step 46. If a decoration flag is raised or if no gradation value is “0”, no decoration flag is raised (S45) and the flow proceeds to step 46. In step 46 it is determined whether no decoration flag is raised in a pixel No. (i−character width) and whether the gradation value is “0”. If no decoration flag is raised and if the gradation value is “0”, a decoration flag is raised and the flow returns to step 41. If a decoration flag is raised or if no gradation value is “0”, no decoration flag is raised (S48) and the flow returns to step 41. This operation is repeated. When in step 41 the pixel is in the interior painting area, the flow is terminated and the flow returns to the main flow.

FIG. 13D shows a sub-flow D that is jumped from step 24 of the main flow. In step 51 of FIG. 13D it is determined whether no decoration flag is raised in a pixel No. (i+character width) and whether the gradation value is “0”. If no decoration flag is raised and the gradation value is “0”, a decoration flag is raised (S52) and the flow proceeds to step 54. If a decoration flag is raised or if no gradation value is “0”, no decoration flag is raised (S53) and the flow proceeds to step 54. In step 54 it is determined whether no decoration flag in a pixel No. (i−1) and whether the gradation value is “0”. If no decoration flag is raised and the gradation value is “0”, a decoration flag is raised (S55) and the flow proceeds to step 57. If a decoration flag is raised or if no gradation value is “0”, no decoration flag is raised (S56) and the flow proceeds to step 57. In step 57 it is determined whether no decoration flag is raised in a pixel No. (i−character width) and whether the gradation value is “0”. If no decoration flag is raised and the gradation value is “0”, a decoration flag is raised (S58) and the flow returns to the main flow of FIG. 13A. If a decoration flag is raised or if no gradation value is “0”, no decoration flag is raised (S59) and the flow returns to the main flow of FIG. 13A.

FIG. 13E shows a sub-flow E that is jumped from step 27 of the main flow. In step 61 of FIG. 13E it is determined whether no decoration flag is raised in a pixel No. (i +character width) and whether the gradation value is “0”. If no decoration flag is raised and the gradation value is “0”, a decoration flag is raised (S62) and the flow proceeds to step 64. If a decoration flag is raised or if no gradation value is “0”, no decoration flag is raised (S63) and the flow proceeds to step 64. In step 64 it is determined whether no decoration flag is raised in a pixel No. (i+1) and whether the gradation value is “0”. If no decoration flag is raised and the gradation value is “0”, a decoration flag is raised (S65) and the flow proceeds to step 67. If a decoration flag is raised or if no gradation value is “0”, no decoration flag is raised (S66) and the flow proceeds to step 67. In step 67 it is determined whether no decoration flag is raised in a pixel No. (i−1) and whether the gradation value is “0”. If no decoration flag is raised and the gradation value is “0”, a decoration flag is raised (S68) and the flow proceeds to step 70. If a decoration flag is raised or if no gradation value is “0”, no decoration flag is raised (S69) and the flow proceeds to step 70. In step 70 it is determined whether no decoration flag is raised in a pixel No. (i−character width) and the gradation value is “0”. If no decoration flag is raised and if the gradation value is “0”, a decoration flag is raised (S71) and the flow returns to the main flow of FIG. 13A. If a decoration flag is raised or if no gradation value is “0”, no decoration flag is raised (S72) and the flow returns to the main flow of FIG. 13A.

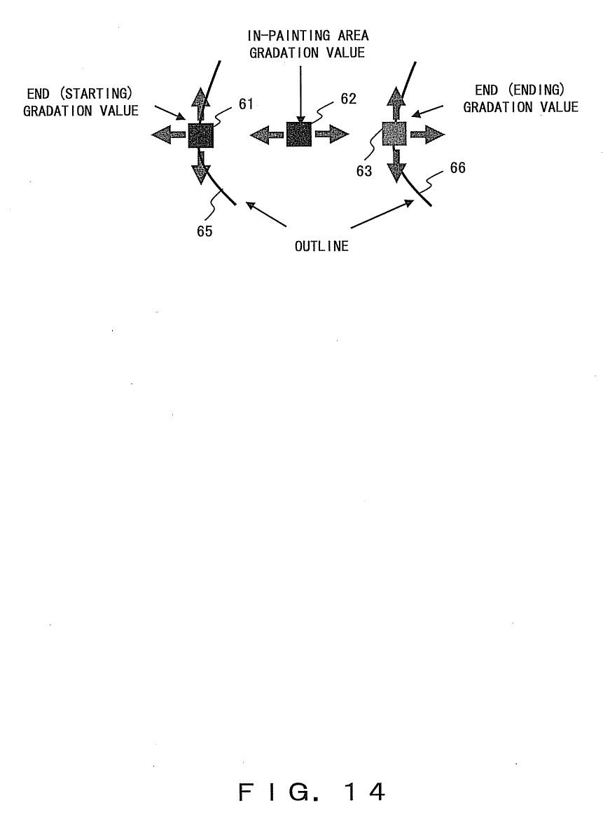

The processes of the above-described flows can be simplified as shown in FIG. 14. FIG. 14 explains a range that affects the decoration flag position setting of the preferred embodiment of the present invention. As shown in FIG. 14, if the gradation value 61 of an end pixel which an outline 65 vertically crosses is equal to or more than the threshold when the pixel indicates a starting point, three directions of upper, lower and left that are indicated by arrow marks are decoration flag position setting candidates. If the gradation value 62 of the pixel is equal to or more than the threshold when the pixel is in the painting area, two directions of left and right that are indicated by arrow marks are decoration flag position setting candidates. Furthermore, if the gradation value 63 of an end pixel which an outline 66 vertically crosses is equal to or more than the threshold when the pixel indicates an ending point, three directions of upper, lower and right that are indicated by arrow marks are decoration flag position setting candidates. If the gradation value of each pixel is less than the threshold when referring to it, a decoration flag is set in the currently referenced pixel itself.

Thus a decoration flag position is set and a decoration flag is set. In the above-described process of raising a decoration flag, an area, the bit of a gradation value of whose pixel is operated can also be processed from eight directions (upper/lower/left/right directions and each diagonal line direction) instead of four directions (upper/lower/left/right directions).

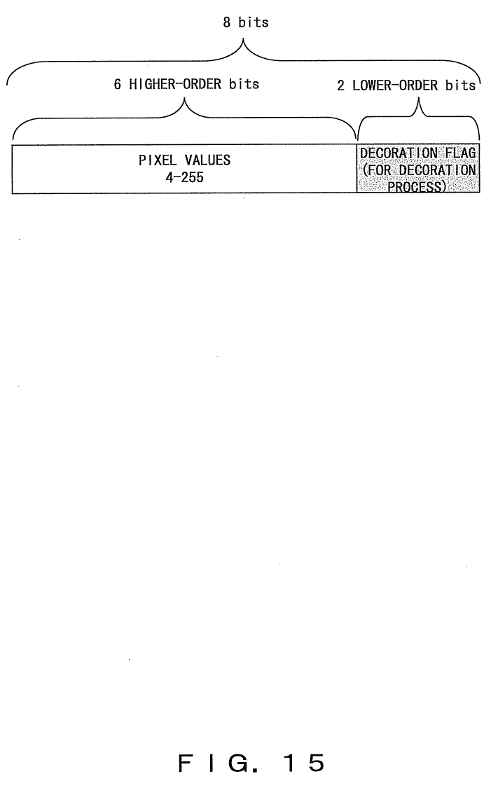

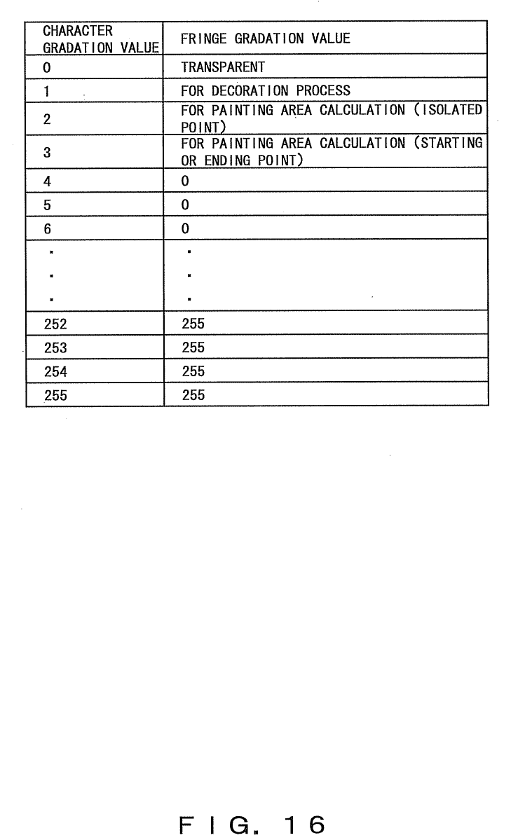

FIG. 15 shows the first format example indicating where of the gradation value the decoration flag of the preferred embodiment of the present invention is assigned. In the first format example shown in FIG. 15, a decoration flag is assigned to only one place. Two lower-order bits can express character outline end information and a character decoration process. FIG. 16 shows the pixel value-flag correspondence table in the first format example shown in FIG. 15. As known from FIG. 16, a decoration flag is expressed by two lower-order bits. “1” is used for the decoration process and “2” and “3” are used for the painting area calculation.

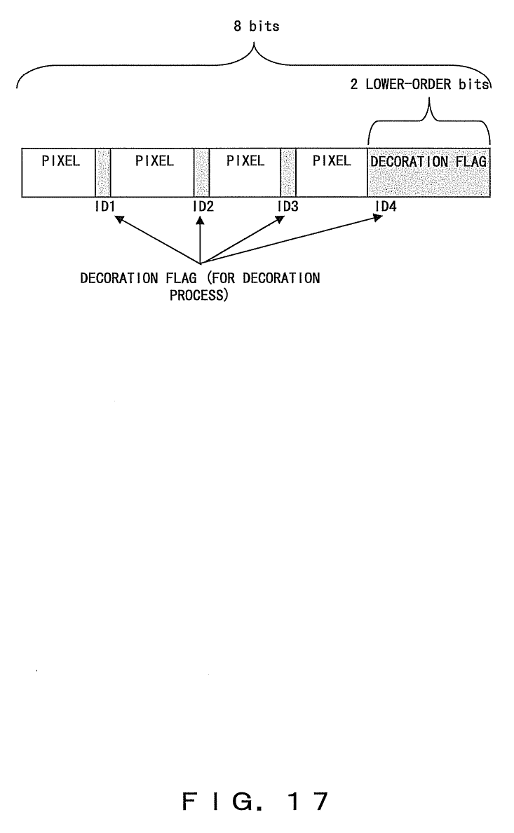

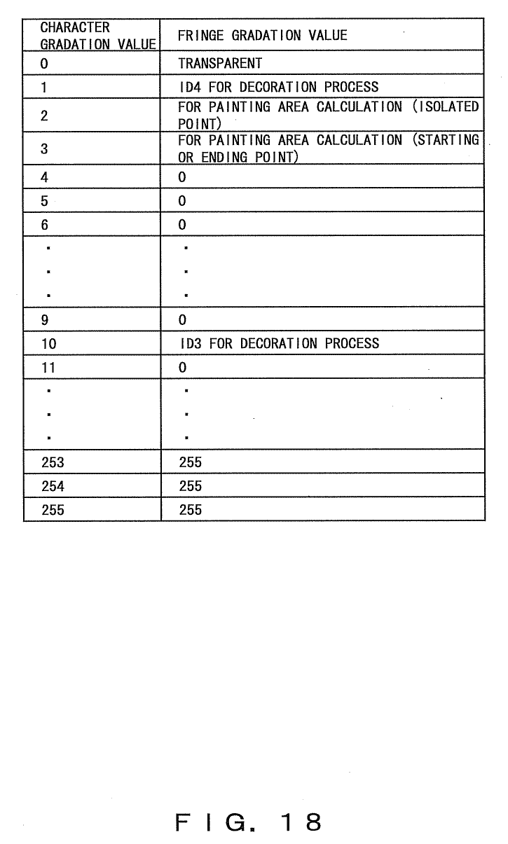

FIG. 17 shows the second format example indicating where of the gradation value the decoration flag of the preferred embodiment of the present invention is assigned. In the second format example shown in FIG. 17, a decoration flag is assigned to a plurality of places. Character outline end information and a decoration flag (ID No.: ID4) can be assigned to the two lower-order bits. Furthermore, decoration flags (ID Nos. ID3-ID1) can be assigned to a higher-order bit. FIG. 18 shows the pixel value-flag correspondence table in the second format example shown in FIG. 17. As known from FIG. 18, decoration flags are assigned to not only two lower-order bits but also a higher-order bit. In this case, “2” and “3” are used for painting area calculation as in FIG. 16. Furthermore, for the decoration process, flag ID Nos. ID4 and ID3 are assigned to “1” and “10”, respectively. Flag Nos. ID2 and ID1 other than these are not shown in the table of FIG. 18.

An equation for calculating to which of the gradation values a decoration flag is assigned is shown below. However, in this equation, the maximum gradation value and minimum gradation value in the whole character image range are used. Nevertheless, the maximum and minimum gradation values in part of the character image range can also be used.

Calculation equation=(Maximum gradation value−Minimum gradation value)/Number of outline gradation

For example, if the character outline of a character image that is expressed by 256 gradation of 0 through 255 is expressed by four gradations, the following result is obtained.

Calculation equation=(255−0)/4=64

Therefore, using the gradation value 64 as the reference, it can be determined that a decoration process flag ID Nos. ID4, ID3, ID2 and ID1 are gradation values 0-63, 64-127, 128-191 and 192-255, respectively. By this method, decoration process flags (ID Nos.) can be uniformly-assigned without any gradation value bias.

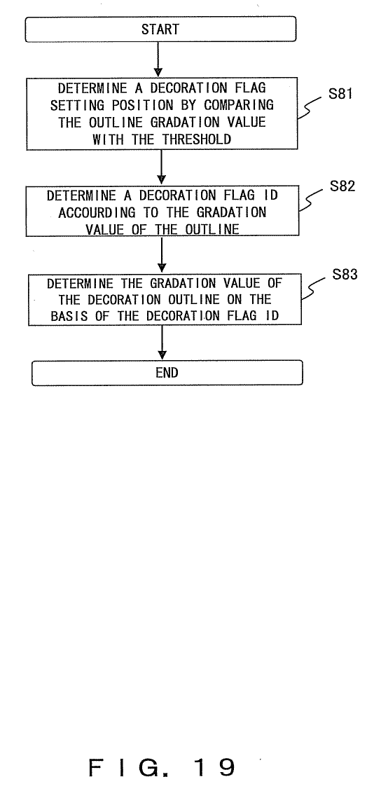

FIG. 19 is a flowchart determining the gradation value of a decoration outline using decoration process flags (ID Nos.) shown in FIGS. 17 and 18. In FIG. 19, firstly, a decoration flag setting position is determined comparing a threshold with an outline gradation value (S81). Then, a decoration flag ID is determined according to the outline gradation value in the determined position (S82). Then, the gradation value of a decoration outline is determined on the basis of the decoration flag ID (S83).

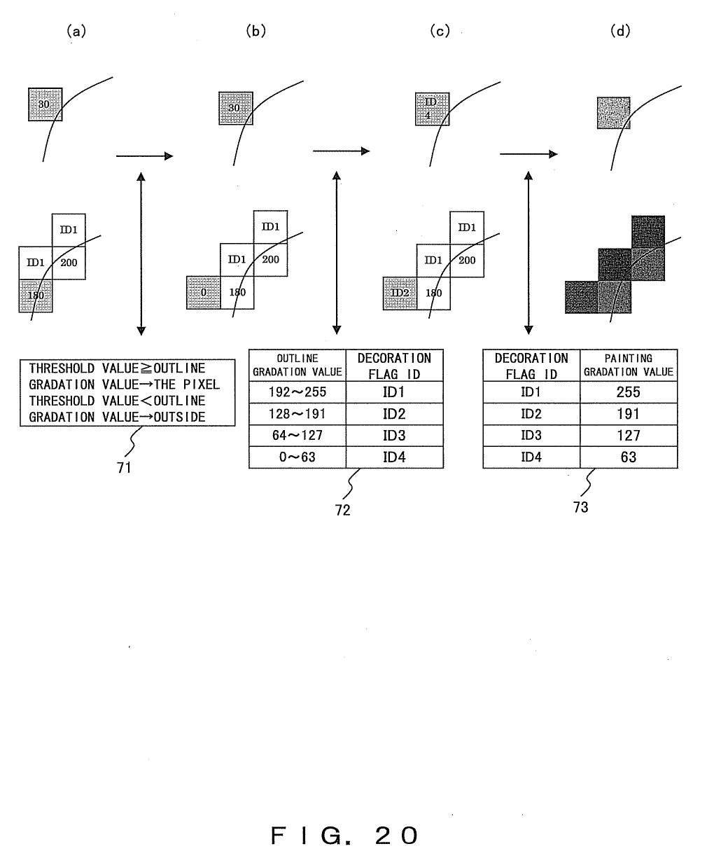

FIG. 20 is a timing chart explaining the gradation value process of the decoration outline according to the flowchart shown in FIG. 19. The top section of FIG. 20 shows the case where the outline gradation value is equal to or less than the threshold, the middle section of FIG. 20 shows the case where the outline gradation value is more than the threshold and the stage transits, using comparison tables 71-73 shown in the bottom section. Firstly, the top section of FIG. 20 is described. Since the outline gradation value is less than the threshold in a stage “a”, in a stage “b”, a decoration flag position is set and a decoration flag is set using the comparison table 71. In a stage “c” it is found using the comparison table 72 that the gradation value is 30 and that a decoration flag ID corresponds to ID4. In a stage “d” it is found according to the comparison table 73 that a painting gradation value corresponding to the decoration flag ID4 is 63 and the outline is painted out by the painting gradation value 63.

Next, the middle section of FIG. 20 is described. In this case, the outline gradation value process is already completed by the scan of the immediately previous line and as a result, a decoration flag ID1 is set in an outline gradation value 200. Since in the scan of this line, the outline gradation value is more than the threshold in the stage “a” according to the comparison table 71, in the stage “b”, a decoration flag position is set outside and a flag is set outside. It is found according to the comparison table 72 that in the stage “c”, that the gradation value is 180 and that a decoration flag ID corresponds to ID2. In the stage “d” it is found according to the comparison table 73 that the painting gradation value corresponding to the decoration flag ID2 is 191 and the outline is painted out by the painting gradation value 191.

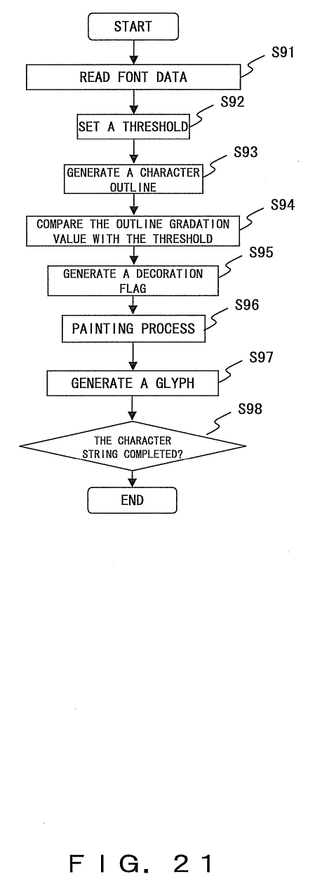

FIG. 21 is the first flowchart explaining the whole process of the character generation processing method of the preferred embodiment of the present invention. Compared with the flow shown in FIG. 7, the flow is the same as that of FIG. 7 except that steps of threshold setting and the comparison of the threshold and the outline gradation value are added in FIG. 21. In FIG. 21, firstly, outline font data is read (S91). Then, a threshold is set (S92). Then, the outline font data is developed according to a character attribute and the outline of a character main body is generated (S93). Then, the set threshold and the outline gradation value are compared (S94). Then, a decoration flag is generated according to a character decoration attribute (S95). Then, the character main body and outline to which decoration flags are attached are painted out (S96). Lastly, a character glyph is generated (S97).

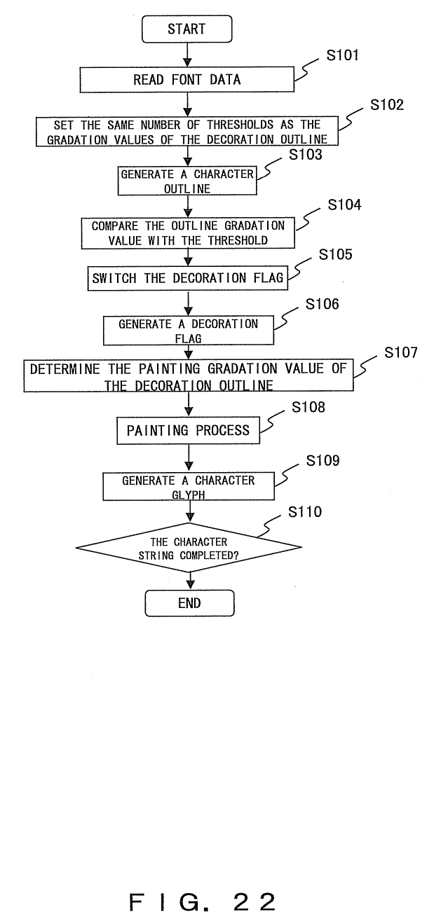

FIG. 22 is the second flowchart explaining the whole process of the character generation processing method of the preferred embodiment of the present invention like FIG. 21. FIG. 22 differs from FIG. 21 only in that the same number of thresholds as that of decoration outline gradation is set in such a way that decoration flags can be switched. In FIG. 22, firstly, outline font data is read (S101). Then, the same number of thresholds as that of decoration outline gradation is set (S102). Then, the outline font data is developed according to a character attribute and the outline of a character main body is generated (S103). Then, the set threshold and the outline gradation value are compared (S104). According to the result of the comparison, a decoration flag is switched (S105). Then, according to a character decoration attribute, a decoration flag is generated (S106). A flag ID No. determining a decoration outline gradation value is attached to the set decoration flag. Then, the decoration outline painting gradation value is determined (S107). Then, the character main body and outline are painted out (S108). Lastly, a character glyph is generated (S109).

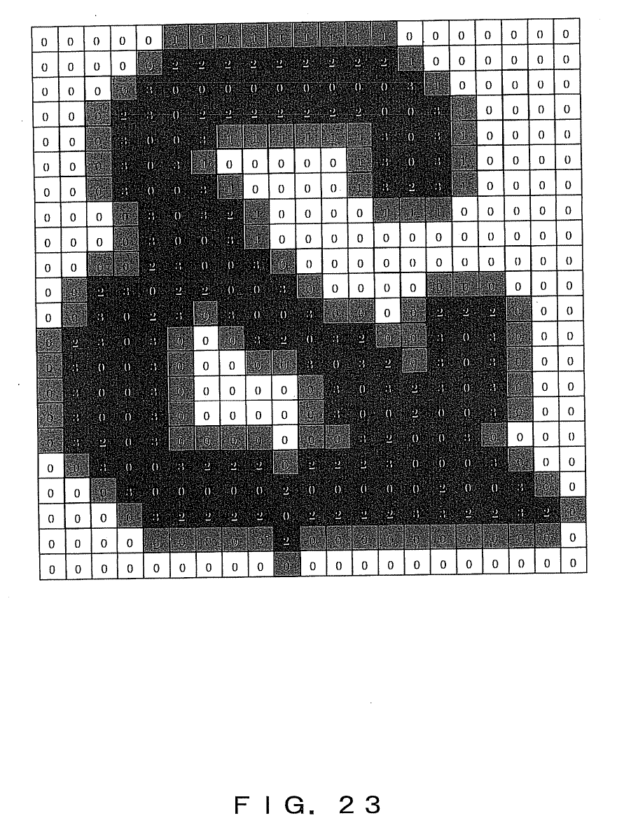

FIG. 23 shows an example of a decoration character obtained by the painting process of the preferred embodiment of the present invention. As already described with reference to FIG. 8, in the painting process, the followings are defined.
(1) The pixel in which two lower-order bits are raised is a paint starting or ending pixel.
(2) The pixel in which one lower-order bit is raised is a single painting pixel.

### If lines are scanned according to the following rules in the outline font development, a character interior can be painted.

(3) When a pixel in which two lower-order bits are raised is met, up to the two subsequent lower-order bits are painted out.
(4) When a pixel in which one lower-order bit is raised is met, the pixel is painted out.

Thus, by repeating the calculation of the number of times an outline vertically crosses a pixel and the XOR bit operation of a target pixel and checking one lower-order bit of the number of vertical crossing, the followings are determined.
(5) If the number of times a pixel in which one lower-order bit is raised is met is odd, the pixel is in a painting area.
(6) If the number of times a pixel in which one lower-order bit is raised is met is even, the pixel is outside a painting area.

### Since calculation, such as addition or the like is not used, high-speed processing can be realized.

If the above-described process is applied to all pixels for each line scan, the line scan must be also applied to a part where no outline crosses, which wastes time. By processing outline data and simultaneously holding the maximum and minimum pixel values by pointers for each line in order to improve this, only necessary parts can be processed and a scan area can be widely reduced, thereby realizing higher-speed process.

When the painting process is completed and a character glyph is generated, it is determined that the process of the character string is completed in step 16 of FIG. 7, step 98 of FIG. 21 or step 110 of FIG. 22. When the completion of the character string is confirmed, the decoration character glyph is stored.

As described above, according to the present invention, since the range of a painting area can be calculated on the basis of the state of two lower-order bits of the gradation value and a character painting process can be realized only by a high-speed logical operation, the generation time of a decoration character with a design whose quality is assured can be reduced.

By raising a flag indicating a decoration process area outside by an arbitrary width according to a character outline gradation value when generating a character outline, the main body and outline to which character decoration is applied of a character can be simultaneously processed, thereby reducing used memory size necessary for a character pattern development area and a font file size.

When applying character expression with a design to outline font, by appropriately selecting the fringe gradation of a character gradation, a flexible character design including character decoration can be realized, thereby generating characters with high customer satisfaction and good appearance.

Although in this specification, a character generation processing method for generating characters with designs is described using the case where it is installed in built-in equipment, such as a cellular phone, a car navigator or the like as an example, the method is not limited to built-in equipment and it can also be effectively applied to character expression with a design in a display device in equipment other than built-in equipment.

What is claimed is:

1. A character generation processing method for generating a character main body including a character outline from data in which character shape information is stored as a character outline and a character with a design, comprising:
generating an outline of a character main body;
setting decoration process contents to be applied to the character main body decoration;
operating in such a way that lower-order bits of a character gradation value of the generated outline can be outline end information;
setting a decoration position in an outer character fringe on the basis of the outline end information for determining whether the outline is located on the left or right side of the main body and the character gradation value of the outline and setting a flag in the position;
generating character decoration by controlling a gradation value of a pixel in which the flag is set; and
painting out the character main body excluding the generated character outline.

2. The character generation processing method according to claim 1, wherein
the flag setting step sets an arbitrary flag setting threshold, switching the flag setting position by comparing the character gradation value of the outline consisting of higher-order bits excluding the operated lower-order bits with the set threshold and setting a flag in the switched position.

3. The character generation processing method according to claim 1, wherein
the flag has a plurality of setting values and
the flag setting step presets the flag setting threshold, switches the plurality of flag values by comparing the character gradation value of the outline with the threshold and sets the switched flag value.

4. The character generation processing method according to claim 3, further comprising
determining a decoration gradation value corresponding to the set flag value.

5. The character generation processing method according to claim 1, wherein
the decoration process content setting step selects and sets one or more of a character size, a character image painting pattern, a bold character pattern, a fringing pattern and a middle-hollowed pattern.

6. The character generation processing method according to claim 1, wherein
if a bold character process is applied when decoration process contents to be applied to the character main body, a bold character is generated by modifying a gradation value of a pixel in which the flag is set to the same gradation value as in the outline of the character main body.

7. The character generation processing method according to claim 1, wherein
if a fringing process is applied when decoration process contents to be applied to the character main body, a fringed character is generated by generating a pixel in which the flag is set in a pattern different from the character main body.

8. The character generation processing method according to claim 1, wherein
if a white-hollowed process is set when decoration process contents to be applied to the character main body, a white-hollowed character is generated by applying specified and white color to a pixel in which the flag is set and the character main body, respectively.

9. A character generation processing apparatus for generating a character main body including a character outline from data in which character shape information is stored as a character outline and a character with a design, comprising:
a unit for generating an outline of a character main body;
a unit for setting decoration process contents to be applied to the character main body decoration;
a unit for operating in such a way that lower-order bits of a character gradation value of the generated outline can be outline end information;
a unit for setting a decoration position in an outer character fringe on the basis of the outline end information for determining whether the outline is located on the left or right side of the main body and the character gradation value of the outline and setting a flag in the position;
a unit for generating character decoration by controlling a gradation value of a pixel in which the flag is set; and
a unit for painting out the character main body excluding the generated character outline.

10. A computer-readable medium encoded with a program for generating a character main body including a character outline from data in which character shape information is stored as a character outline and a character with a design, said program performing:
generating an outline of a character main body;
setting decoration process contents to be applied to the character main body decoration;
operating in such a way that lower-order bits of a character gradation value of the generated outline can be outline end information;
setting a decoration position in an outer character fringe on the basis of the outline end information for determining whether the outline is located on the left or right side of the main body and the character gradation value of the outline and setting a flag in the position;
generating character decoration by controlling a gradation value of a pixel in which the flag is set; and
painting out the character main body excluding the generated character outline.
